(19) United States
(12) Patent Application Publication
(10) Pub. No.: US 2017/0174528 A1
(43) Pub. Date: Jun. 22, 2017

(54) WATER PURIFIER

(71) Applicant: Yinhuan SUN, Dongguan (CN)

(72) Inventor: Yinhuan SUN, Dongguan (CN)

(21) Appl. No.: 15/257,875

(22) Filed: Sep. 6, 2016

(30) Foreign Application Priority Data
Dec. 17, 2015 (CN) 201521063486.X

(51) Int. Cl. C02F 1/00; B01D 61/18; B01D 29/58; C02F 1/44; B01D 35/30; B01D 35/153; B01D 61/20; B01D 65/02; B01D 61/14; B01D 29/66

(52) U.S. Cl. CPC C02F 1/002; B01D 61/145; B01D 61/18; B01D 29/58; B01D 29/665; B01D 35/306; B01D 35/153; B01D 61/20; B01D 65/027; C02F 1/444; B01D 2201/301; C02F 2307/02; B01D 2311/2649; B01D 2321/04; B01D 2321/12

(57) ABSTRACT

A water purifier, including a housing, a piston cylinder, a base, and a dust cap. The housing includes a water inlet end and a water outlet end, and a composite filter material and an ultrafiltration membrane are disposed in the housing to constitute a filter element. The piston cylinder is sleeved on the housing. The upper end of the piston cylinder is provided with a suction nozzle. The base includes an upper part and a lower part. The upper part includes a lower bayonet and an upper bayonet. The lower part includes a multipurpose interface and a water inlet nozzle. The dust cap is disposed on the upper end and covers the suction nozzle. The central part of the dust cap protrudes downward to form a flexible sealing plug. The water inlet end of the housing is secured to the lower bayonet of the base.

### CROSS-REFERENCE TO RELATED APPLICATIONS

Pursuant to 35 U.S.C. §119 and the Paris Convention Treaty, this application claims the foreign priority benefit of Chinese Patent Application No. 201521063486.X filed Dec. 17, 2015, the contents of which, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

Field of the Invention

The invention relates to a portable water purifier, and in particular, to a multipurpose micro water purifier having backwashing function.

Description of the Related Art

Existing portable water purifiers can only be loaded using corresponding devices of specific size and type. This is inconvenient and limits wider use of water purifiers. In addition, the filter element of the water purifiers tends to clog and is difficult to clean.

### SUMMARY OF THE INVENTION

In view of the above-described problems, it is one objective of the invention to provide a multipurpose micro water purifier having backwashing function, which is able to clean the filter element and the filter material in use, thus prolonging the service life of the filter element and the filter material. In addition, the water purifier is able to match various kinds of water containers, and the connection of the two is simple, thus increasing the supply of the water source for the water purifier. All of this is favorable to the popularization of the water purifier.

To achieve the above objective, in accordance with one embodiment of the invention, there is provided a multipurpose micro water purifier having backwashing function, comprising a housing, the housing comprising a water inlet end and a water outlet end, and a composite filter material and an ultrafiltration membrane being disposed in the housing to constitute a filter element; a piston cylinder, the piston cylinder being sleeved on the housing, and an upper end of the piston cylinder comprising a suction nozzle; a base, the base comprising an upper part and a lower part; the upper part comprising a lower bayonet and an upper bayonet; the lower part comprising a multipurpose interface and a water inlet nozzle; and a dust cap, the dust cap being disposed on the upper end of the piston cylinder and covering the suction nozzle; a central part of the dust cap protruding downward to form a flexible sealing plug. The water inlet end of the housing is secured to the lower bayonet of the base; a lower end of the piston cylinder is secured to the upper bayonet of the base; the water inlet nozzle of the base communicates with the water inlet end of the housing; the water outlet end of the housing communicates with the suction nozzle of the piston cylinder.

In a class of this embodiment, a sealing ring is disposed between the housing and the piston cylinder.

In a class of this embodiment, a check valve base is disposed on the upper end of the piston cylinder, and a check valve is mounted on the check valve base; the check valve base is disposed between the suction nozzle and the water outlet end of the housing.

Advantages of the water purifier according to embodiments of the invention are summarized as follows: the piston cylinder is sleeved on the housing and thus can impose intense pressure on the space inside the housing, thereby facilitating the washing of the filter element. Meanwhile, the arrangement of the multipurpose interface and the water inlet nozzle of the base enables the water purifier to connect to and take water from various kinds of water containers. In addition, the suction nozzle on the upper end of the piston cylinder enables the water purifier to connect to various kinds of hoses and output purified water to various kinds of containers.

### BRIEF DESCRIPTION OF THE DRAWINGS

The invention is described hereinbelow with reference to the accompanying drawings, in which:

FIG. 1 is a cross-sectional view of a multipurpose micro water purifier having backwashing function in Example 1;

FIG. 2 is a schematic diagram of a multipurpose micro water purifier having backwashing function of FIG. 1 where a dust cap is removed;

FIG. 3 is a schematic diagram of a multipurpose micro water purifier having backwashing function of FIG. 1 where a piston cylinder is pulled upwards;

FIG. 4 is a cross-sectional view of a multipurpose micro water purifier having backwashing function in Example 2;

FIG. 5 is a schematic diagram of a multipurpose micro water purifier having backwashing function of FIG. 4 where a piston cylinder is pulled upwards;

FIG. 6 is a schematic diagram of a multipurpose micro water purifier having backwashing function of Example 2 in a backwashing state; and

FIG. 7 is a cross-sectional view of a multipurpose micro water purifier having backwashing function in Example 3 where a piston cylinder is pulled upwards.

### DETAILED DESCRIPTION OF THE EMBODIMENTS

For further illustrating the invention, experiments detailing a multipurpose micro water purifier having backwashing function are described below. It should be noted that the following examples are intended to describe and not to limit the invention.

### Example 1

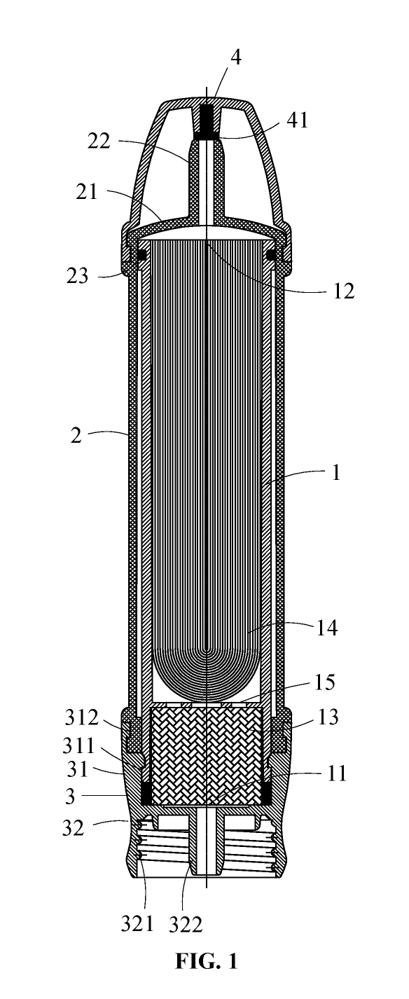

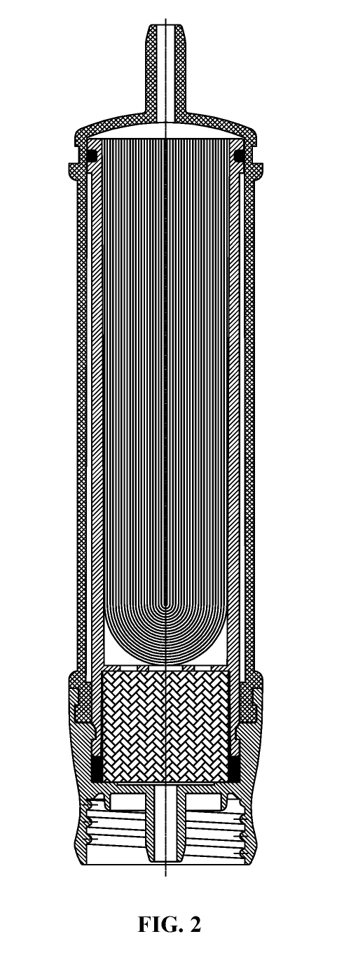

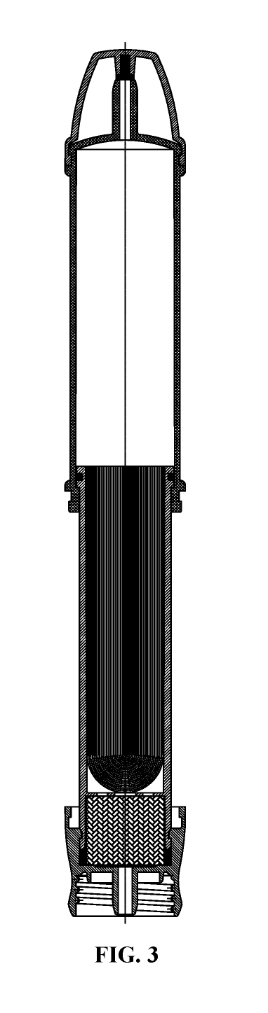

As shown in FIGS. 1-3, a multipurpose micro water purifier comprises a housing 1, a piston cylinder 2, a base 3, and a dust cap 4. The housing 1 comprises a water inlet end 11 and a water outlet end 12. A composite filter material 13 and an ultrafiltration membrane 14 are disposed in the housing to constitute a filter element. A spacer 15 is disposed between the composite filter material 13 and the ultrafiltration membrane 14 to prevent the composite filter material 13 from blocking the ultrafiltration membrane 14. The piston cylinder 2 is sleeved on the housing 1. An upper end of the piston cylinder 2 comprises a cover 21, and a suction nozzle 22 is disposed on the cover 21. The water outlet end 12 of the housing 1 communicates with the suction nozzle 22 of the piston cylinder 2, and purified water can be sucked out via the suction nozzle 22. The base 3 is disposed on the bottoms of the housing 1 and the piston cylinder 2. The base 3 comprises an upper part 31 and a lower part 32. The upper part 31 comprises a lower bayonet 311 and an upper bayonet 312. The lower part 32 comprises a multipurpose interface 321 and a water inlet nozzle 322. The water inlet nozzle 322 of the base 3 communicates with the water inlet end 11 of the housing 1. A sealing ring 23 is disposed between the housing 1 and the piston cylinder 2. The bottom of the housing 1 is secured to the lower bayonet 311 of the base 3. The bottom of the piston cylinder 2 is secured to the upper bayonet 312 of the base 3. Optionally, the lower bayonet 311 and the upper bayonet 312 are provided with sealing rings. The dust cap 4 is disposed on the upper end of the piston cylinder 2 and covers the suction nozzle 22. A central part of the dust cap 4 protrudes downward to form a flexible sealing plug 41. As shown in FIG. 1, the multipurpose interface 321 of the base 3 is able to connect to various kinds of bottles or water bags. When the piston cylinder 2 is pulled, because the a sealing ring 23 is disposed between the piston cylinder 2 and the housing 1, the suction nozzle 22 is blocked up by the flexible sealing plug 41 of the dust cap 4, so that a negative pressure is formed in the piston cylinder 2, and water is input from the bottles or water bags into the water inlet end 11 of the housing 1 via the water inlet nozzle 322; then the water is filtrated by the composite filter material 13 and the ultrafiltration membrane 14; the purified water passes through the water outlet end 12 and is stored in the piston cylinder 2, as shown in FIG. 3. When pressing the dust cap 4 downward, the piston cylinder 2 moves downward, and the purified water stored in the piston cylinder 2 enters into the housing 1, thus backwashing the ultrafiltration membrane 14 and the composite filter material 13.

### Example 2

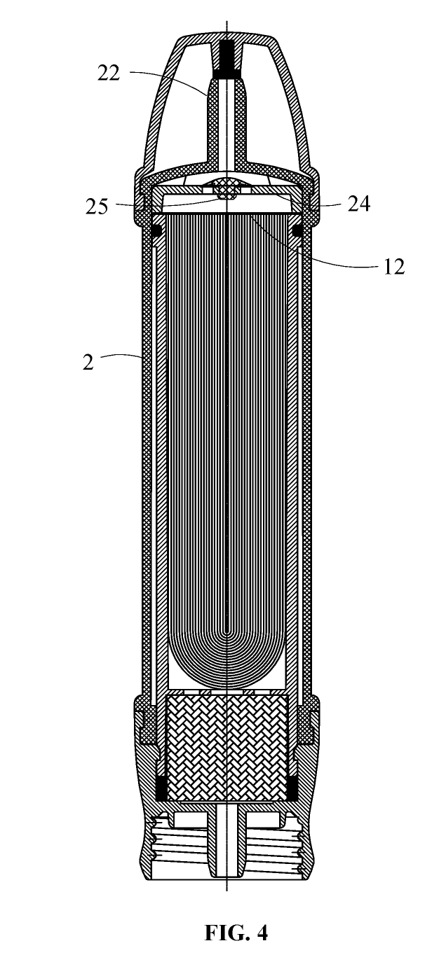

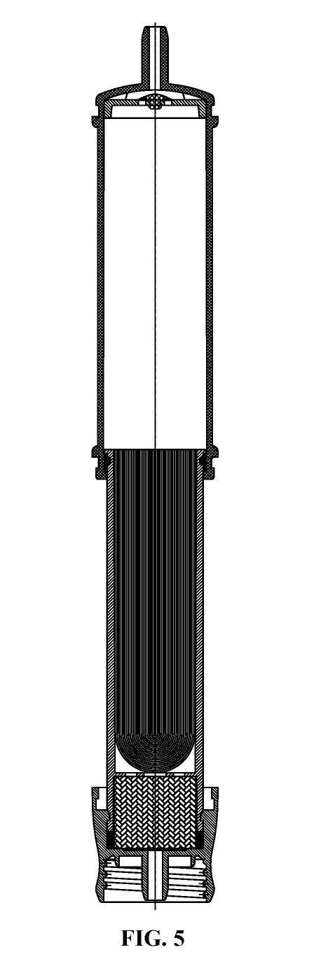

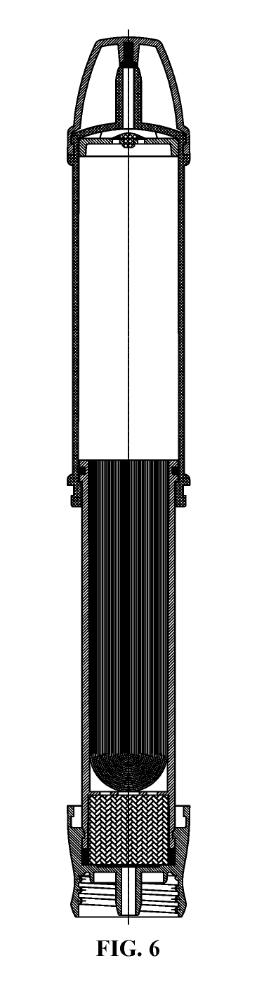

As shown in FIGS. 4-6, the water purifier in the example follows the basic structure of the multipurpose micro water purifier in Example 1. The upper end of the piston cylinder 2 further comprises a check valve base 24, and a check valve 25 is mounted on the check valve base 24. The check valve base 24 is disposed between the suction nozzle 22 and the water outlet end 12 of the housing 1. Therefore, a user has many options, he can suck purified water directly via the suction nozzle 22, or suck the purified water after pushing and pulling the piston cylinder 2 to filtrate the water, or squeeze the purified water into other containers. Optionally, the user can also mount the dust cap 4 on the piston cylinder 2 and push and pull the piston cylinder 2 to perform the backwashing. Thus the water purifier is multi-functional.

### Example 3

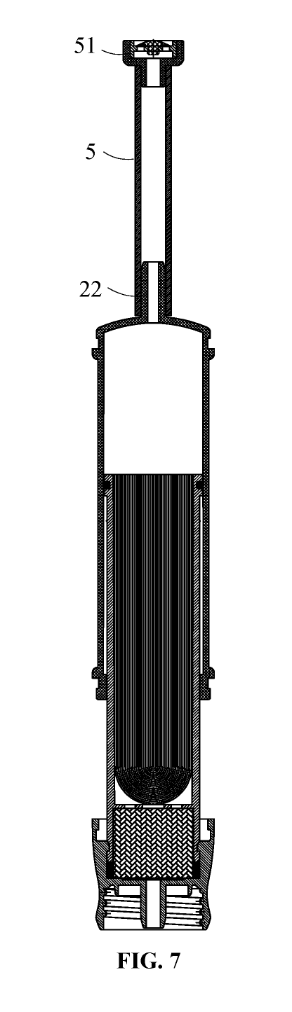

As shown in FIG. 7, the water purifier in the example follows the basic structure of the multipurpose micro water purifier in Example 1. The suction nozzle 22 is connected to a flexible hose 5, and an end of the flexible hose 5 is connected to a main body 51 of a check valve. Therefore, as described by Example 2, a user has many options, he can suck purified water directly via the suction nozzle 22, or suck the purified water after pushing and pulling the piston cylinder 2 to filtrate the water, or squeeze the purified water into other containers. Optionally, the user can also remove the hose 5, mount the dust cap 4 on the piston cylinder 2, and push and pull the piston cylinder 2 to perform the backwashing. Thus the water purifier is multi-functional.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A water purifier, comprising:
a housing, the housing comprising a water inlet end and a water outlet end;
a filter element comprising a composite filter material and an ultrafiltration membrane, the filter element being disposed in the housing;
a piston cylinder having an upper end, the piston cylinder being sleeved on the housing, the upper end of the piston cylinder comprising a suction nozzle;
a base, the base comprising an upper part and a lower part; the upper part comprising a lower bayonet and an upper bayonet; the lower part comprising a multipurpose interface and a water inlet nozzle; and
a dust cap having a central part, the dust cap being disposed on the upper end of the piston cylinder and covering the suction nozzle; the central part of the dust cap protruding downward and forming a flexible sealing plug;
wherein
the water inlet end of the housing is secured to the lower bayonet of the base;
a lower end of the piston cylinder is secured to the upper bayonet of the base;
the water inlet nozzle of the base communicates with the water inlet end of the housing; and
the water outlet end of the housing communicates with the suction nozzle of the piston cylinder.

2. The water purifier of claim 1, wherein a sealing ring is disposed between the housing and the piston cylinder.

3. The water purifier of claim 1, wherein a check valve base is disposed on the upper end of the piston cylinder, and a check valve is mounted on the check valve base; the check valve base is disposed between the suction nozzle and the water outlet end of the housing.

4. The water purifier of claim 2, wherein a check valve base is disposed on the upper end of the piston cylinder, and a check valve is mounted on the check valve base;
the check valve base is disposed between the suction nozzle and the water outlet end of the housing.
